(19) United States
(12) Patent Application Publication
(10) Pub. No.: US 2003/0055749 A1
(43) Pub. Date: Mar. 20, 2003

(54) INFORMATION TECHNOLOGY ASSET MANAGEMENT

(76) Inventors: CORA L. CARMODY, OAK HILL, VA (US); JOHN R. WARBURTON, ARLINGTON, VA (US)

Correspondence Address: LOWE HAUPTMAN GOPSTEIN, GILMAN & BERNER LLP, 1700 DIAGONAL ROAD, SUITE 310, ALEXANDRIA, VA, 22314

(21) Appl. No.: 09/303,436

(22) Filed: May 3, 1999

(51) Int. Cl. G06F 17/60

(52) U.S. Cl. 705/28

(57) ABSTRACT

The purpose of the present invention called Information Technology Asset Management (ITAM) is to develop and monitor the processes and metrics to perform the orderly planning, acquisition, entry, use, insight, refresh, and retirement of all IT assets (desktop computers, servers, network components, software, etc.). The goal of the present invention is to lower the Total Cost of Ownership (COT), increase a company's technological agility, and improve the company's cash management. Other benefits are cycle-time reduction in the procurement, payment, and accounting of IT assets, with substantial cost savings in software licensing, property taxes, and stealth (or shadow) support. Some examples of processes include processes within Acquisition/Procurement, Deployment/Accounts Receivable, Accounts Payable, Desktop Setup/Configuration, End User Support such as Support Center functions of Problem Resolution, Moves/Adds/Changes, and Application Support, financial insight processes such as Baseline Inventory, Asset Reconciliation, Software License Management, Asset Tech Refresh, Asset Reallocation and Asset Disposal. The methodology of ITAM is fundamental in implementing a Common Operating Environment (COE) and the standards policies, processes and IT architecture associated with COE.

### FIELD OF THE INVENTION

The present invention relates generally to Information Technology (IT) asset management, and more particularly, relates to a life cycle process to develop and monitor the processes and metrics to perform the orderly planning, acquisition, entry use, insight, refresh, and retirement of all IT assets (desktop computers, servers, network components, software, etc.).

### BACKGROUND OF THE INVENTION

Information technology asset management refers to the management of IT assets including hardware and software. The management of IT assets can be used to reduce the annual cost of purchasing and using a desktop computer. There are some estimates of yearly costs for a desktop including purchase price, maintenance and the like of approximately $10,000-$12,000 per year. Most of the annual costs are spent in operating a desktop and are not accounted for using traditional methods.

This cost can be reduced by managing IT assets. However, this problem is made particularly acute because many organizations purchase IT assets from many decentralized locations. In the absence of standards, decentralized spending leads to a severe lack of interoperability, inefficient spending without volume purchase agreements and a low ability to implement modern technological solutions. There is a lack of insight into what is possessed by the company.

Often with the lack of centralized IT spending, there are processing inefficiencies. A process inefficiency means “we spend too much and wait too long” for IT assets to be ordered and deployed. This can result from having to get quotes and lack of standardization of hardware and software. There is a lack of asset insight meaning that taxes are still paid on assets long disposed of. There is frequently a lack of uniform support and supportability including a help desk, back-ups and dueling DLLs (Dynamic Link Library) resulting from uninformed installs. A DLL contains one or more functions that are compiled, linked, and stored separately from the processes that use them. The operating system maps the DLLs into the address space of the calling process when the process is starting or while it is running. There is a lack of technological agility leading to a lack of migration planning and migration implementation (manual software distribution).

In summary, the total Total Cost of Ownership (TCO) is increased if IT assets are not properly managed. Only about 25% of the TCO includes capital expenditures. The remaining 75% includes, for example, end user operations, administrative operations and technical support. Significant savings reducing the TCO can be achieved by proper management of IT assets and a need exists for such a methodology.

### SUMMARY OF THE INVENTION

It is, therefore, an object of the present invention to provide a method for developing and monitoring the process and metrics to perform the orderly planning, acquisition, entry use, insight, refresh, retirement of all IT assets.

It is another object of the present invention to provide a methodology for IT capital planning and to reduce the cost of purchasing.

It is yet another object of the present invention to provide a methodology for reducing the overall total cost of ownership of an IT asset.

The purpose of the present invention called Information Technology Asset Management (ITAM) is to develop and monitor the processes and metrics to perform the orderly planning, acquisition, entry, use, insight, refresh, and retirement of all IT assets (desktop computers, servers, network components, software, etc.). The goal of the present invention is to lower the Total Cost of Ownership (COT), increase a company's technological agility, and improve the company's cash management. Other benefits are cycle-time reduction in the procurement, payment, and accounting of IT assets, with substantial cost savings in software licensing, property taxes, and stealth (or shadow) support. Some examples of processes include processes within Acquisition/Procurement, Deployment/Accounts Receivable, Accounts Payable, Desktop Setup/Configuration, End User Support such as Support Center functions of Problem Resolution, Moves/Adds/Changes, and Application Support, financial insight processes such as Baseline Inventory, Asset Reconciliation, Software License Management, Asset Tech Refresh, Asset Reallocation and Asset Disposal.

The methodology of ITAM is fundamental in implementing a Common Operating Environment (COE) and the standards policies, processes and IT architecture associated with COE. Many federal agencies desire to put COE into place, seeing the cost benefit of the services associated with ITAM, also called Seat Management, IT Outsourcing or Infrastructure Modernization.

Many of the problems solved the present invention have never been worked out satisfactorily anywhere in industry, such as seamless integration of IT asset information with accounting asset information with systems management and software license information.

Some Key Benefits and Metrics of the ITAM are as follows:

IT Capital Planning

Benefits

Reduction of Redundancy

Ability to Standardize

Obtain Volume Pricing

Acquisition

Benefits

Reduced Process Time

Reduced Product Costs

Indicators

From when Originator generates PR to when PR received in Procurement

# of times configuration dollars do not agree with PO price

Time from order is placed to when Vendor delivers PC

# of Requests returned to originator

Support Center

Benefits

Avoiding Costs Incurred Through Shadow Support

Quicker Resolution Time

Indicators

M—# seconds/rings before SP answers phone

M—# minutes/hours before SP responds to email request for support

M—# minutes/hours before SP responds to Web-based request for support M—% calls resolved during first call.

M—#hours/days to problem resolution

M—#minutes/hours before IIS responds to SP-originated requests

M—# minutes/hours before IIS responds to direct faxed request for support

M—# hours before unresolved problem forwarded to Second Tier Support

M—# hours/days before Second Tier responds to request

M—# calls resolved by First Tier

M—# hours/days to Request Fulfillment

M—# day s before changes are sent into Asset Repository

Asset Reconciliation

Benefits

Decrease of Taxes Paid on Absent Equipment

Indicators

M—# of assets in system not found during physical inventory

M—# assets found in physical inventory not found in system

M—% of total assets found only in system

M—% of total assets found only during physical inventory

M—% improvement over prior period of assets found only in system

M—% improvement over prior period of assets found only in physical inventory

M—$ saved/lost in property taxes for assets written off/assets entered into system as determined during asset reconciliation

Software License Management

Benefits

Reduction of Liability Incurred Through Illegal Licenses

Cost Avoidance Through License Reuse

Indicators

M—# of licenses harvested vs. # licenses needed

M—$ saved by not paying for licenses we no longer use

M—$ saved by transferring licenses rather than buying new ones

M—$ saved by upgrading licenses rather than buying new ones

Asset Reallocation

Benefits

Cost Savings Through Better Utilization of Existing Assets

Indicators

M—$ saved by redeployment rather than capital acquisition

These and other objects of the present invention are achieved by a method of managing information technology assets for an enterprise including determining an inventory of IT assets for the enterprise and storing information concerning the IT assets in an asset repository. The IT assets are periodically automatically monitored and any inventory changes are stored in the asset repository. The information stored the asset repository is used for reducing the overall total cost of ownership for the inventory of IT assets.

The foregoing and other objects of the present invention are achieved by a computer architecture including determining means for determining an inventory of IT assets for the enterprise and storing information concerning the IT assets in an asset repository. Monitoring means are provided for periodically automatically monitoring the IT assets and storing any inventory changes in the asset repository wherein the information stored the asset repository is used for reducing the overall total cost of ownership for the inventory of IT assets.

The foregoing and other objects of the present invention are achieved by a computer system including a processor and a memory coupled to the processor, the memory having stored therein sequences of instructions, which, when executed by the processor, causes the processor to perform the steps of determining an inventory of IT assets for the enterprise and storing information concerning the IT assets in an asset repository. The processor periodically automatically monitors the IT assets and stores any inventory changes in the asset repository. The information stored the asset repository is used for reducing the overall total cost of ownership for the inventory of IT assets.

Still other objects and advantages of the present invention will become readily apparent to those skilled in the art from the following detailed description, wherein the preferred embodiments of the invention are shown and described, simply by way of illustration of the best mode contemplated of carrying out the invention. As will be realized, the invention is capable of other and different embodiments, and its several details are capable of modifications in various obvious respects, all without departing from the invention. Accordingly, the drawings and description thereof are to be regarded as illustrative in nature, and not as restrictive.

### BRIEF DESCRIPTION OF THE DRAWINGS

The present invention is illustrated by way of example, and not by limitation, in the figures of the accompanying drawings, wherein elements having the same reference numeral designations represent like elements throughout and wherein:

FIG. 1 is a high level block diagram of a computer architecture usable with the present invention;

FIG. 2 is an overall macro diagram illustrating the overall process to perform the orderly planning, acquisition, entry use, insight, refresh, and retirement of all IT assets; and

FIG. 3 is a logical architecture according to the present invention.

### BEST MODE FOR CARRYING OUT THE INVENTION

A method and apparatus for developing and monitoring the processes and metrics to perform the orderly planning, acquisition, entry use, insight, refresh, and retirement of all IT assets (desktop computers, servers, network components, etc.) are described. In the following description, for purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

Hardware Overview

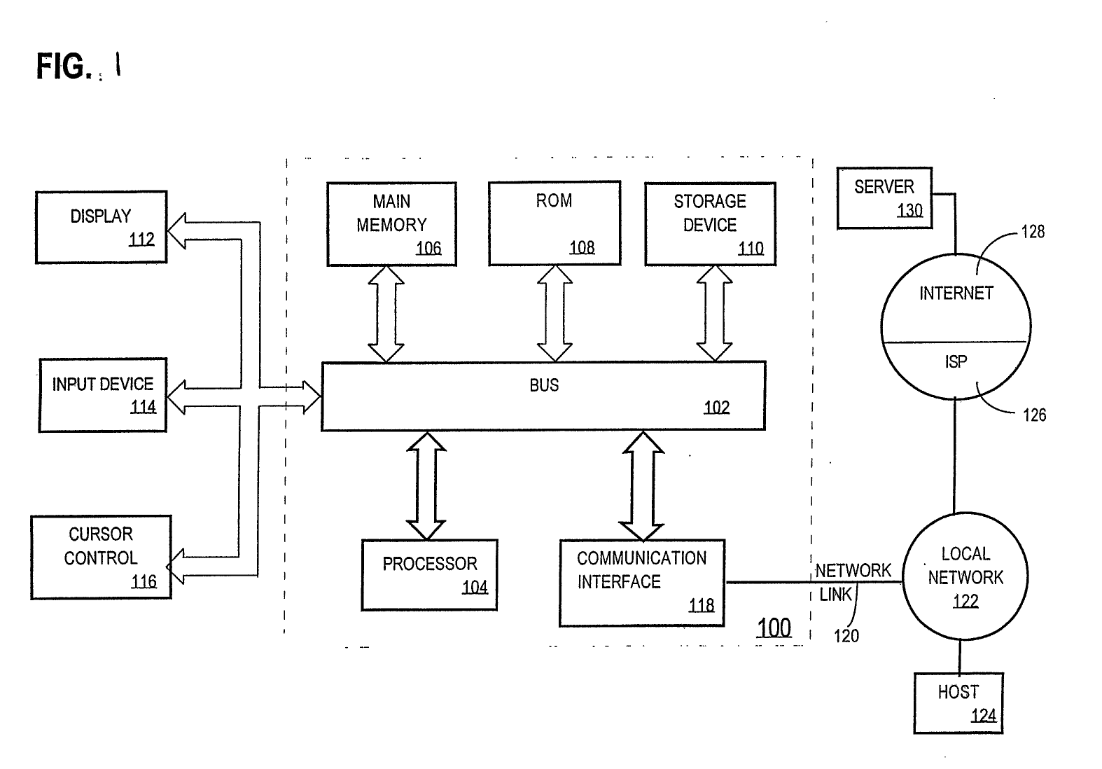

FIG. 1 is a block diagram illustrating an exemplary computer system 100 upon which an embodiment of the invention may be implemented. The present invention is usable with currently available personal computers, mini-mainframes and the like.

Computer system 100 includes a bus 102 or other communication mechanism for communicating information, and a processor 104 coupled with the bus 102 for processing information. Computer system 100 also includes a main memory 106, such as a random access memory (RAM) or other dynamic storage device, coupled to the bus 102 for storing information and instructions to be executed by processor 104. Main memory 106 also may be used for storing temporary variables or other intermediate information during execution of instructions to be executed by processor 104. Computer system 100 further includes a read only memory (ROM) 108 or other static storage device coupled to the bus 102 for storing static information and instructions for the processor 104. A storage device 110, such as a magnetic disk or optical disk, is provided and coupled to the bus 102 for storing information and instructions.

Computer system 100 may be coupled via the bus 102 to a display 112, such as a cathode ray tube (CRT) or a flat panel display, for displaying information to a computer user. An input device 114, including alphanumeric and other keys, is coupled to the bus 102 for communicating information and command selections to the processor 104. Another type of user input device is cursor control 116, such as a mouse, a trackball, or cursor direction keys for communicating direction information and command selections to processor 104 and for controlling cursor movement on the display 112. This input device typically has two degrees of freedom in two axes, a first axis (e.g., x) and a second axis (e.g.,) allowing the device to specify positions in a plane.

The invention is related to the use of a computer system 100, such as the illustrated system to display, develop and monitor the processes and metrics to perform the orderly planning, acquisition, entry use, insight, refresh, and retirement of all IT assets (desktop computers, servers, network components, etc.). According to one embodiment of the invention, developing and monitoring the processes and metrics to perform the orderly planning, acquisition, entry use, insight, refresh, and retirement of all IT assets (desktop computers, servers, network components, etc.) and display is provided by computer system 100 in response to processor 104 executing sequences of instructions contained in main memory 106. Such instructions may be read into main memory 106 from another computer-readable medium, such as storage device 110. However, the computer-readable medium is not limited to devices such as storage device 110. For example, the computer-readable medium may include a floppy disk, a flexible disk, hard disk, magnetic tape, or any other magnetic medium, a CD-ROM, any other optical medium, punch cards, paper tape, any other physical medium with patterns of holes, a RAM, a PROM, an EPROM, a FLASH-EPROM, any other memory chip or cartridge, a carrier wave embodied in an electrical, electromagnetic, infrared, or optical signal, or any other medium from which a computer can read. Execution of the sequences of instructions contained in the main memory 106 causes the processor 104 to perform the process steps described below. In alternative embodiments, hard-wired circuitry may be used in place of or in combination with computer software instructions to implement the invention. Thus, embodiments of the invention are not limited to any specific combination of hardware circuitry and software.

Computer system 100 also includes a communication interface 118 coupled to the bus 102. Communication interface 108 provides a two-way data communication as is known. For example, communication interface 118 may be an integrated services digital network (ISDN) card or a modem to provide a data communication connection to a corresponding type of telephone line. As another example, communication interface 118 may be a local area network (LAN) card to provide a data communication connection to a compatible LAN. In the preferred embodiment communication interface 118 is coupled to a virtual blackboard. Wireless links may also be implemented. In any such implementation, communication interface 118 sends and receives electrical, electromagnetic or optical signals which carry digital data streams representing various types of information. Of particular note, the communications through interface 118 may permit transmission or receipt of the policies, processes, systems and controls for the orderly planning, acquisition, entry, use, insight, refresh, and retirement (reallocation and/or disposal) of all IT assets. For example, two or more computer systems 100 may be networked together in a conventional manner with each using the communication interface 118.

Network link 120 typically provides data communication through one or more networks to other data devices. For example, network link 120 may provide a connection through local network 122 to a host computer 124 or to data equipment operated by an Internet Service Provider (ISP) 126. ISP 126 in turn provides data communication services through the world wide packet data communication services through the world wide packet data communication network now commonly referred to as the “Internet” 128. Local network 122 and Internet 128 both use electrical, electromagnetic or optical signals which carry digital data streams. The signals through the various networks and the signals on network link 120 and through communication interface 118, which carry the digital data to and from computer system 100, are exemplary forms of carrier waves transporting the information.

Computer system 100 can send messages and receive data, including program code, through the network(s), network link 120 and communication interface 118. In the Internet example, a server 130 might transmit a requested code for an application program through Internet 128, ISP 126, local network 122 and communication interface 118. In accordance with the invention, one such downloaded application provides for developing and monitoring the processes and metrics to perform the orderly planning, acquisition, entry use, insight, refresh, and retirement of all IT assets (desktop computers, servers, network components, etc.) as described herein.

The received code may be executed by processor 104 as it is received, and/or stored in storage device 110, or other non-volatile storage for later execution. In this manner, computer system 100 may obtain application code in the form of a carrier wave.

The present invention is directed at standardizing configurations and support for microprocessor-based microcomputers, application software, including upgrades and updates to all delivered software, assorted peripherals to operate primarily in a networked office environment. The present invention provides process support and desktop management services intended to afford a new way of acquiring and managing desktop computing resources.

The present invention advantageously:

1. Reduces process time and product costs in the acquisition of desktop systems and software.

2. Increases precision of asset insight and knowledge of asset movement.

3. Provides uniform support and increases supportability through the adoption of a standard platform and software applications.

4. Avoids costs incurred through shadow support.

5. Provides quicker resolution time of problems.

6. Decreases cycle time and other costs to introduce new technologies into operational use.

7. Improves help desk support through insight into end user configurations.

8. Reduces software overbuying through improved software licensing strategies.

The objective of the present invention is to acquire quality desktop computing services as a utility through a single point of contact and to achieve substantial cost savings in attaining and managing desktop assets. The present invention will achieve cost efficiencies in improving the Enterprise IT Asset Management process. This includes moving to a standard common operating environment, shortening the tech refresh cycle to reduce dependencies on technology no longer supported by general industry, and the gradual migration from labor-intensive on-site support to remote support using an integrated automated system of support.

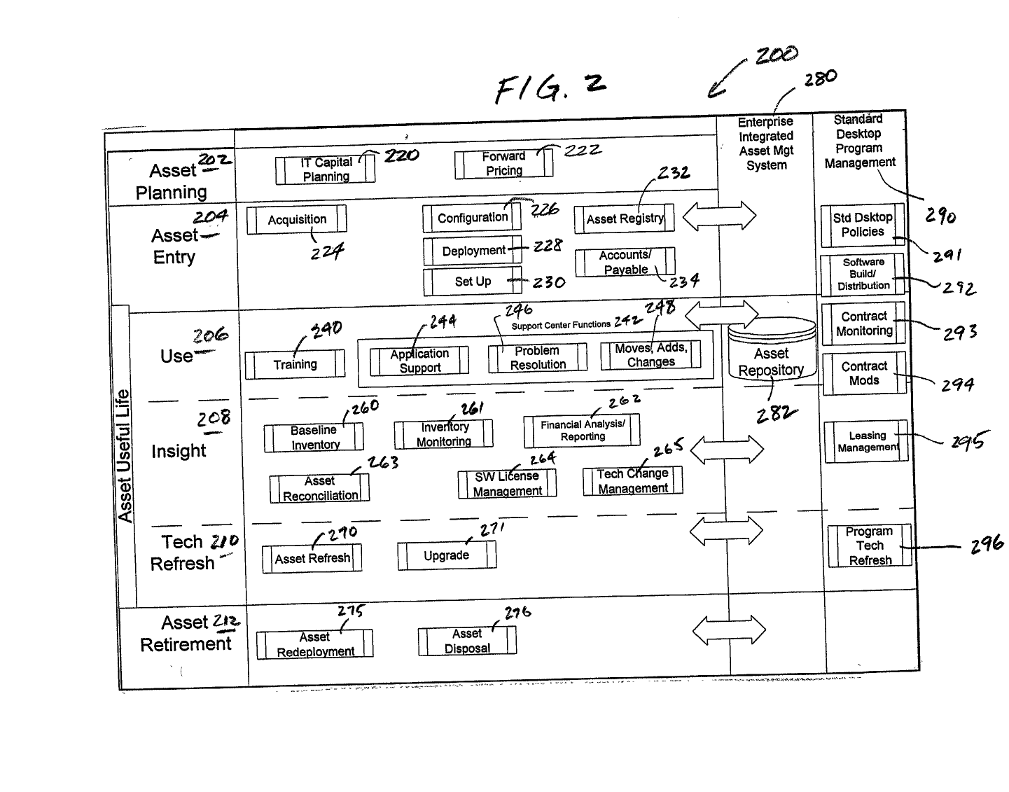

Refer now to FIG. 2 where a macro flow diagram of the ITAM process 200 is depicted. The ITAM process 200 includes an asset planning stage 202, an asset entry stage 204, a use stage 206, an insight stage 208, a tech refresh stage 210 and an asset retirement stage 212.

The asset planning stage 202 includes an IT capital planning process 220 and a forward pricing process 222. The IT capital planning process 220 can be done manually or automatically. The IT capital planning process 220 is used to predict the needs of the enterprise for the following year based on feedback from the ITAM process as described below. Based on the IT capital planning process 220, the forward pricing process 222 is used to provide estimates for volume purchasing of IT assets such as desktops, etc. Advantageously, using volume purchasing, desktop acquisition costs can be greatly reduced.

The asset entry stage 204 includes an acquisition process 224, a configuration process 226, a deployment process 228, a set up process 230, an asset registry process 232, and an accounts payable process 234.

The initial externally supported process in the asset entry stage 204 is the acquisition process 224 of desktop microcomputer systems, hardware and software. The acquisition process 224 will include a web-based ordering process that accommodates ordering by pre-defined bundles of hardware and software. These bundles will be the standard definition of hardware configuration and software content by user-classification and by level of platform (Standard, Mid, High or Mobile). The user of ITAM should provide access to the most accurate costed configurations both through a web page accessible by all employees, but also by providing an electronic file to their Procurement organization for posting on a frequency of at least monthly. The ordering process shall have the ability to accept license/serial numbers for software products that the organization already owns and is redeploying to the new asset.

Prior to delivery, a configuration process 226 configures, integrates and makes operational each requested configuration provided by the acquisition process 224. The integration process 226 includes loading the required operating and system support software, designated software applications and integrating any organizationally provided software or equipment. The software and equipment to be integrated should be identified on each delivery order. The user of ITAM provides the support necessary for the using organization to provide in electronic media and by remote access, software build images by user type for configuration at an ITAM user's integration facility or at a manufacturer's facility, as well as the capability to make replacements or modifications to these builds. The user of ITAM provides the control and configuration management of these build images. The user of ITAM will maintain control over the original build images, as well as making them available to site administrators for local rebuilds, if necessary. The configuration process will support crediting the purchase of software licenses against any special licensing agreements. Additional support will be provided for alternative strategies of software license management, such as reallocation of harvested licenses, or providing for competitive upgrades by accepting the serial number of the competing product (e.g., a WordPerfect serial number to obtain Microsoft Word as an upgrade, not a new product). The configuration process 226 ends with the bar code tagging, or equivalent, of the asset and the preparation of an electronic asset record to be transmitted in a time frame coincidental to the delivery of the equipment. The asset record shall pass through key information fields from the delivery order, to include, for example, user data, location destination information, financial information, such as charge number, and hardware/software ordered, with any retained license information. The configuration process 226 updates this record with the actual attributes of the hardware/software, in particular all license and version numbers of loaded software.

A Deployment (Receiving) and Asset Registry process is depicted at 228. The process for reporting missing or defective items within shipment should permit initiation of corrective within 48 hours. Upon the successful completion of the deployment process 228, the electronic asset record will be accepted into a Registry/Asset Management system 232, examples of which include Standard Office Automation (SOA) tool available from PRC, McLean, Va. and the PeopleSoft Asset Management module available from PeopleSoft, Pleasanton, Calif.

A set-up service 230 includes delivery of configured equipment and desk-side set-up to the end-user's facility. An end-user notification process included as part of the set-up service process 230 should ensure site access and end-user availability in the most time efficient manner possible.

An accounts payable process 234 is a conventional accounts payable process in which each of the assets purchased during the acquisition process 224 is paid for. The accounts payable process 234, however, provides information into the asset repository 282 which can be later used by the IT capital planning process 220 and for the forward pricing process 222.

The use stage 206 includes a training process 240 and support center functions 242 which includes an application support process 244, a problem resolution process 246, and a moves, adds, changes process 248.

ITAM provides an approach to the training services process 240 to include all equipment, tools, documentation, facilities and labor needed to provide training. The ITAM user should conduct training of Commercial Off the Shelf (COTS) office packages for beginner, intermediate and advanced users. This has been shown to have a cost reducing impact on Total Cost of Ownership.

The application support process 244 is designed to provide users with direct assistance in the use of COTS software products. The support may range from the answering of basic “how do I” questions to product development and assistance in the migration of critical application products from one software implementation to another, for example, migrating large amounts of data from File Maker Pro format to Microsoft Access. COTS software support may vary based on hours of service, volume of incidents and service priority. COTS software support is available through a toll free telephone number, and provide support for desktop, utility and system software.

The problem resolution process 246 provides technical skills, infrastructure and tools necessary to support end user requirements. This shall include the ability to isolate, identify, track, report and resolve end-user hardware and software problems, as well as to meet other end user needs such as modifying and maintaining desktop configurations. The ITAM process provides a problem management and resolution process to include both telephone and web-entry means of reporting problems. This process must ensure appropriate and timely escalation needed to meet individual performance requirements.

In order to provide the end users with an improved capability to maintain a current desktop-computing environment, ITAM will provide for the technical refresh of individual desktop assets, as well as the upgrade of separable components within a desktop system. The tech refresh of the choice of IT Assets under control (e.g., keeping the choice of configurations to order as current as possible) is covered under Program Management (see program tech refresh 296 discussed in detail below).

During an asset's useful life, an ITAM user provides Moves, Adds and Changes (MACs) 248 designed to allow for immediate incidental enhancements to the existing infrastructure. MACs may range from simple to complex and may include installing, uninstalling, moving to a new location, reinstalling, adding a device, and installing new cabling, etc.

The insight stage 208 includes a baseline inventory process 260, an inventory monitoring process 261, a financial analysis/reporting process 262, an asset reconciliation process 263, a software license management process 264 and a technical change management process 265.

The baseline inventory process 260 can be performed at any time during the ITAM process. Preferably, the process is performed initially to determine all of the IT assets, both hardware and software, deployed in the user's network. The inventory monitoring process 261 should be a continuously performed process. By continuous, it is meant that periodic monitoring, such as daily should be performed on each of the IT assets within the user's network to determine what hardware and software is being deployed at each of the network nodes. For example, it should be automatically determined how much RAM is currently deployed on each of the nodes. This can determine, for example, when a user cannot run Microsoft Excel because memory has been taken from a desktop. The financial analysis/reporting process 262 provides an accounting of the financial aspects of the assets—this includes calculating the monthly depreciation and property tax for each capital asset, and proper charging of those and other expenses on all assets. The asset reconciliation process 263 is an important module because it reconciles the assets that are believed to be in physical inventory versus financial records of the assets. For example, property taxes may have to be paid on a particular asset located within a particular state in the United States. However, this asset may no longer be located in that particular state and may have been moved to another state. The asset reconciliation process provides a reconciliation between the actual physical inventory and the inventory being maintained in the asset registry 232. The software license management process 264 is also an important aspect of the present invention. For example, rather than buy a complete new Microsoft Office package to upgrade to Microsoft Office 98, it may be possible to purchase an upgrade package from Microsoft Office 95 to Microsoft Office 98 representing a significant cost savings. The technical change management process 265, provides for the utilization of asset information in the decision making and planning for technology migrations. For example, the total cost of migrating an organization from Office 4.0 to Office 95, cannot be calculated without insight into how many processor upgrades, RAM upgrades, and hard drive upgrades are required. The software license management process also helps the ITAM user avoid liability or reduce liability incurred through illegal licensing and advantageously provides license reuse and harvesting. Harvesting means upgrading from, for example, a Microsoft Office 95 operating environment to Microsoft Office 98 environment, by using an unused, yet legally valid license. The asset reconciliation process 263 decreases the amount of taxes paid on absent equipment.

The tech refresh stage 210 includes an asset refresh process 270 and an upgrade process 271. The asset refresh process 270 involves performing a tech refresh on some aspect of an existing asset, such as a memory upgrade. This includes the process of keeping both the asset and the asset record up to date and current at all times. This differs from the upgrade process 271 in that the upgrade process involves replacing the asset with a different asset altogether, again making the requisite recording changes.

The asset retirement state 212 includes an asset redeployment process 275 and an asset disposal process 276. The Asset Redeployment process 275 interfaces both the acquisition process 224 and the MACs process 248. This may take place either as an end user acquires a new platform, or as the termination of an employee frees up a platform. A Redeployment Pool can be formed of available hardware assets, as well as software licenses available either with the hardware asset or available as separated from the hardware asset. For example, an asset can be redeployed if one employee upgrades from a 500 meg hard drive to a 600 meg hard drive. By creating a redeployment pool, this pool can be checked by other employees and hardware or software can be redeployed or reallocated instead of purchased without the redeployment pool, another employee may well be unaware of the existence of this IT asset.

The Asset Disposal 276 is used at the end of the asset's useful life. A simple means of disposing the asset in the most financial-advantageous manner to (organization) possible. The disposal process will include provisions to recoup usable licenses into the Reallocation Pool.

All of the information gathered, collected and determined from the asset planning stage 202, the asset entry stage 204, the use stage 206, the insight stage 208, the tech refresh stage 210 and the asset retirement stage 212 is stored in an asset repository 282. The asset repository 282 can be stored on any type of storage device which is accessible by the ITAM user and forms the heart of the enterprise integrated asset management system.

The Standard Desktop Program Management 290 includes a standard desktop policies methodology 291, a software build/distribution methodology 292, a contract monitoring methodology 293, a contract modifications methodology 294, a leasing management methodology 295, and a program tech refresh methodology 296. Other IT Assets should follow the same process as for desktops.

The Standard Desktop Acquisition policies methodology 291 defines the policy for the purchase of configurations for microprocessor-based microcomputers, applications software, including upgrades and updates to all delivered software, and assorted peripherals to operate primarily in a networked office environment. Within the text of this policy, and in general usage, the term “desktop” is used to convey all microprocessor-based equipment configured for a single user, including notebook, laptop, or mobile configurations.

The software build/distribution module 292 defines the policies for the purchase of custom and COTS software. The contract monitoring module 293 defines the policy for monitoring contracts. This includes, for example, monitoring the agreements with asset manufacturers, as well as any external service providers or IT outsourcers used. Any modifications required to these agreements, such as changes to service level agreements would take place under the contract modifications module 294. The leasing management module 295 is used to define the leasing arrangements, if the assets are leased as opposed to purchased. The program tech refresh methodology 296 is used to define procedures used for tech refresh stage 210. This is essential to ensure that all assets offered on an ITAM program are as technologically up to date as possible, within the requirements of the organization.

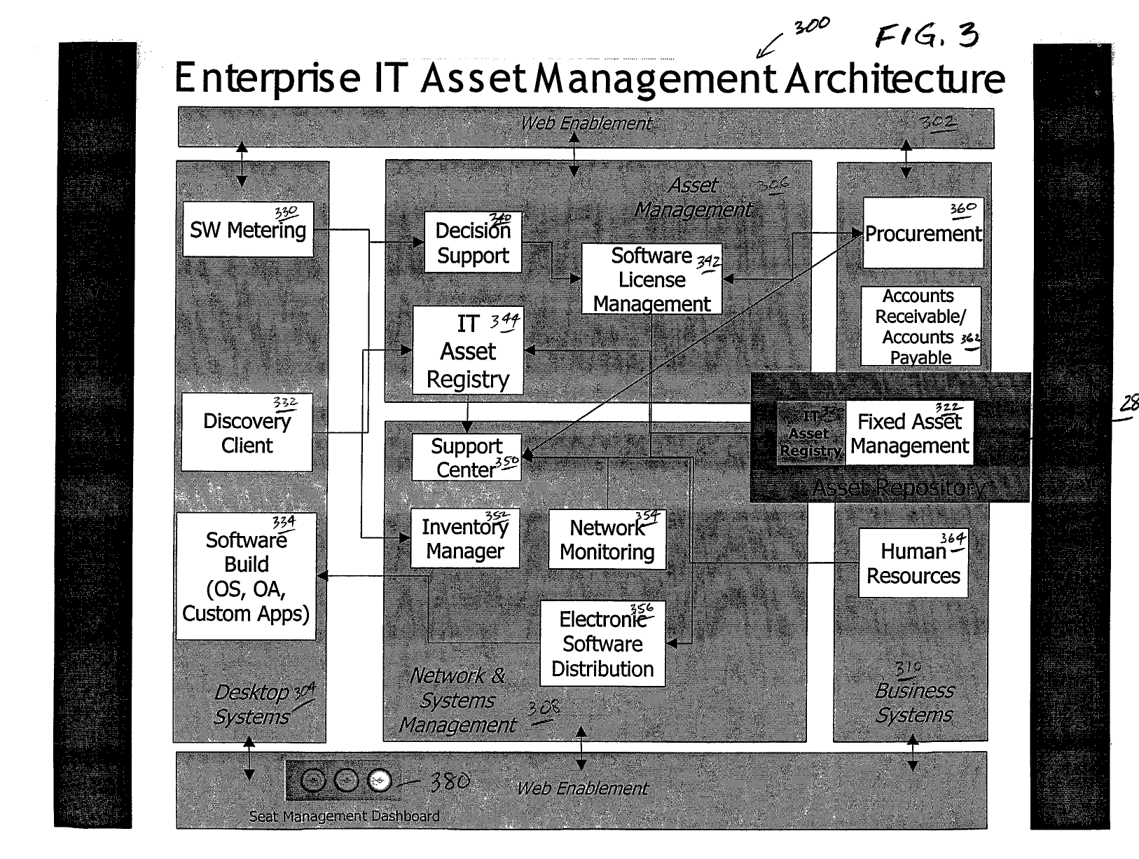

As depicted in FIG. 3, an enterprise IT asset management architecture 300 is illustrated. The enterprise IT asset management architecture 300 includes the asset repository 282, a web enablement module 302, a desktop systems module 304, an asset management module 306, a network and systems management module 308 and a business systems module 310. The asset repository 282 includes an IT asset registry 320 and a fixed asset management module 322.

The web enablement module 302 is a conventional web enablement tool, such as a Microsoft Internet browser or a Netscape browser, that will be used to show the output of the other modules 304-310. This output will be consolidated and depicted in an easy to comprehend method, called an IT Asset Management or Seat Management dashboard 380. The concept is very similar to that of a car dashboard, which provides the driver immediate access to metrics necessary to perform the car driving process in the most effective manner possible.

The desktop systems module 304 includes a software metering module 330, a discovery client 332 and a software build module 334. The software metering module 330 is a very useful tool for metering software to various users. For example, in the past, in an accounting department, only two accountants may, for example, use Microsoft Power Point. However, most accounting departments would typically purchase an entire Microsoft Office package including Microsoft Power Point for all accountants in the accounting department. By using the software metering module 330, it can be determined which users are using particular purchased software modules and software could be metered to these various users using software metering module 330. WinVista is one example of a metering product that fills many of these requirements. The software metering module 330 also supports the function of the asset reconciliation process 263.

The discovery client 332 is used to determine what assets are being used by the enterprise. The discovery client 332 performs the functions of baseline inventory 260, inventory monitoring 261, asset reconciliation 263 and software license management 264.

The software build module provides a standard software image build to the desktop asset, and is used to provide input to application support 244 and problem resolution 246.

The asset management module includes a decision support module 340, a software license management module 342 and an IT Asset registry module 344. The decision support module 340 receives information from both the software metering module 330 and the discovery client 332. The decision support module 340 is used to support the IT capital process 220 and the forward pricing process 222. The decision support module 340 provides information to the software license management module 342. The software license management module 291 provides the functionality previously described for software license management process 264. The IT asset registry 344 receives information from the discovery client 332 and the asset repository 282. In the IT asset registry is included for information regarding all of the IT assets owned or controlled by the enterprise.

The network systems and management module 308 includes a support center 350, an inventory manager 352, a network monitoring module 354 and an electronic software distribution module 356. The network and system management module 308 includes the support center 350. The support center receives information from the IT Asset registry. Support center 350 can be, for example, an 800 number which employees can call to receive help from a help desk. The support center 350 should also include a knowledge base for use as an on-line resource.

The inventory manager 352 is linked to the IT asset registry 344. The inventory manager 352 is used in the asset entry stage 204 including acquisition process 224, the configuration process 226, the deployment process 228 and the set-up process 230. The network monitoring module 354 provides input to support center functions, by providing information on the general state of the network and network nodes. 242. Tools such as HP Openview and CA Unicenter provide this kind of functionality. The electronic software distribution module 356 provides information to the software build module 334. The electronic software distribution module 356 can be used to deploy software on various computers through network connectivity rather than have each of the software modules individually loaded on remotely separated computers. Tools such as Microsoft SMS, Tivoli Management Framework, and Cognet provide these capabilities.

The business systems module 310 includes a procurement module 360, an accounts receivable/accounts payable module 362 and a human resources module 364. The procurement module 360 provides functionality of the acquisition process 224. The procurement module 360 also interfaces with the support center 350. The procurement process 360 receives information from all of the processes shown in FIG. 2. The accounts receivable/accounts payable module 362 provides the functionality of process 243 in FIG. 2. As depicted in FIG. 3, the functionality of the asset repository 282 resides in the asset management module 306, the network and systems management module 308 and the business systems module 310. The human resources module 364 provides information to the ITS at registry. Typical business systems include PeopleSoft, Baan, SAP, and Oracle.

The IT asset registry 320 differs significantly from the fixed asset management tool 322 employed by most companies. For example, the fixed asset management tool 322 could be a standard accounting tool used in most accounting departments. For example, if an accounting department gets a purchase request for twelve PCs, there will be one record in the fixed asset management of module 322. Then if four of those PCs are moved, it is difficult for a typical accounting system to keep track of the four PCs versus the twelve PCs because there is only one record.

Most fixed asset management modules 322 do not include information such as how much memory is on a particular computer or how large a hard drive is on this computer. The information contained by most accounting departments is not technologically complete or accurate to be able to do the type of migration planning envisioned by the method. The IT asset registry provides both static and dynamic asset insight as discussed below.

Static Asset Insight

Static Asset Insight refers to managing the accurate asset information at the point the asset enters the enterprise, throughout its useful life, from the vantage point of both the fixed asset accounting system and the infrastructure support systems.

When an asset enters the accounting system, certain information about the asset is recorded at the baseline inventory 280. Each record in the fixed asset accounting system includes information on the asset financial owner, depreciation rate, and so on, including summary description of the platform. For infrastructure support systems, asset insight is needed as to the location of the asset and the technical composition of the asset. This involves more detailed information than typically is collected in a fixed asset accounting system. Information such as serial number, size of memory, size of hard drive, processor speed, as well as the contents of the initial software build should be recorded.

Both the financial information and the configuration information represent basically static information and keeping that static information current involves some actions during the useful life of the asset. For example, when a change takes place, such as moving it from one department id to another id, or physical location, the information needs to be kept current for accountability purposes using the MAC process 248.

Dynamic Asset Insight

With an architecture that provides dynamic asset insight, it is necessary to maintain and use extended information about the asset during its useful life from several perspectives. Using capabilities for desktop monitoring (hardware and software) inventory information is periodically validated on that platform. So, for example, if on Thursday Bill Smith has a platform with 32 megabytes of memory and on Friday the same Bill Smith now has the same platform but for some reason it only has 4 megabytes of memory, periodic polling of all the assets will reveal this information. This information is accessible in real time to the support center staff so more intelligent and accurate problem resolution can take place over the phone. Diagnostic discussions can now take place such as “Well, Mr. Smith, I see why Microsoft Excel won't run, you now only have 4 mbs of memory. Do you know what happened to the other 28 mbs of memory?”

Desktop monitoring, also called desktop discovery, keeps the information on the asset up to date in the IT Asset Repository 282, making it available for applications such as Decision Support 340. This is essential for the most accurate assessments of technology migration planning—for example, knowing the exact cost of moving the enterprise to a new desktop application or upgrading versions involves knowing the incidental costs, such as which platforms need processor or memory upgrades, or which platform already has some version of the software. This insight helps very much with accurate software license management, and enables some cost avoidance by knowing when an upgrade license is needed as opposed to buying a new license. Accurate software license management also helps reduce enterprise liability by being able to detect illegal copies of software, and the capability to harvest unused licenses and reduce the procurement of unnecessary licenses.

Another application of Dynamic Asset Insight is the software metering application 330. This can provide such information as what platforms are actually using the loaded software applications, and how much time is spent with different features of the software. This can support decisions such as moving to server-based concurrent licenses, where the number of users can be more realistically calculated, or what users need more training on the applications they use most, or on features of the applications they are not using.

It should now be apparent that a life cycle process has been described capable of reducing the total cost of ownership of IT assets by providing the policies, processes, systems and controls for the orderly planning, acquisition, entry, use, insight, refresh, and retirement (reallocation and/or disposal) of all IT assets.

It will be readily seen by one of ordinary skill in the art that the present invention fulfills all of the objects set forth above. After reading the foregoing specification, one of ordinary skill will be able to affect various changes, substitutions of equivalents and various other aspects of the invention as broadly disclosed herein. It is therefore intended that the protection granted hereon be limited only by the definition contained in the appended claims and equivalents thereof.

What is claimed is:

1. A method of managing information technology assets for an enterprise, comprising:
determining an inventory of IT assets for the enterprise and storing information concerning the IT assets in an asset repository;
periodically automatically monitoring the IT assets and storing any inventory changes in the asset repository; and
using the information stored the asset repository for reducing the overall total cost of ownership for the inventory of IT assets.

2. The method of claim 1, comprising planning capital purchasing based on said determining step.

3. The method of claim 1, comprising configuring, deploying and setting up acquired IT assets and storing information concerning the IT assets in the asset repository.

4. The method of claim 1, comprising training users of IT assets using the information stored in the IT asset repository.

5. The method of claim 1, comprising providing application support and problem resolution using information stored in the asset repository.

6. The method of claim 1, wherein IT assets includes desktop computers, servers, network components and computer software.

7. The method of claim 1, comprising estimating purchasing volume for the next year based on information stored in the asset repository.

8. The method of claim 1, comprising acquiring IT assets using a web-based ordering process that accommodates ordering by pre-defined bundles of hardware and software.

9. The method of claim 1, comprising remotely building software images for each computer by user type.

10. The method of claim 1, comprising refreshing computer software IT assets when new software becomes available based on the information stored in the asset repository.

11. The method of claim 1, comprising migrating an IT asset from one desktop to another desktop based on the information stored in the asset repository.

12. The method of claim 1, comprising creating a redeployment pool based on the information stored in the asset repository.

13. The method of claim 1, comprising harvesting IT assets based on the information stored in the asset repository.

14. The method of claim 1 comprising metering software to users based upon previous usage information stored in the asset repository.

15. The method of claim 1, comprising reconciling records of IT assets maintained by an accounting department against information stored in the asset repository.

16. A computer architecture, comprising:
determining means for determining an inventory of IT assets for the enterprise and storing information concerning the IT assets in an asset repository;
monitoring means for periodically automatically monitoring the IT assets and storing any inventory changes in the asset repository; and
wherein the information stored the asset repository is used for reducing the overall total cost of ownership for the inventory of IT assets.

17. A computer system, comprising:
a processor; and
a memory coupled to said processor, the memory having stored therein sequences of instructions, which, when executed by said processor, causes said processor to perform the steps of:
determining an inventory of IT assets for the enterprise and storing information concerning the IT assets in an asset repository;
periodically automatically monitoring the IT assets and storing any inventory changes in the asset repository; and
using the information stored the asset repository for reducing the overall total cost of ownership for the inventory of IT assets.
